(19) United States
(12) Patent Application Publication
(10) Pub. No.: US 2024/0072355 A1
(43) Pub. Date: Feb. 29, 2024

(54) LOWER PROTECTIVE COVER AND BATTERY PACK HAVING SAME

(71) Applicant: Samsung SDI Co., Ltd., Yongin-si (KR)

(72) Inventors: Jee Hoon JEON, Yongin-si (KR); Sung Hyun JEON, Yongin-si (KR); Tae Ho JI, Yongin-si (KR)

(21) Appl. No.: 18/446,213

(22) Filed: Aug. 8, 2023

(30) Foreign Application Priority Data
Aug. 26, 2022 (KR) 10-2022-0107690

(51) Int. Cl. H01M 50/242; B60L 50/64; H01M 10/613; H01M 10/6556; H01M 50/204

(52) U.S. Cl. CPC H01M 50/242; B60L 50/64; H01M 10/613; H01M 10/6556; H01M 50/204; B62D 21/15; H01M 2220/20

(57) ABSTRACT

A battery pack includes a battery module configured to accommodate a number of battery cells, and a lower protective cover including a lower panel detachably coupled to a lower portion of the battery module and a number of buffer parts on one surface of the lower panel. A structure of the lower protective cover of the battery pack may be improved to absorb an impact from a lower side of a vehicle. A cross-sectional shape of the buffer part of the lower protective cover may be changed to adjust and design an impact absorption value.

### CROSS-REFERENCE TO RELATED APPLICATION

This application claims priority to and the benefit of Korean Patent Application No. 10-2022-0107690 filed on Aug. 26, 2022, in the Korean Intellectual Property Office, the entire disclosure of which is incorporated herein by reference.

### BACKGROUND

### 1. Field

Embodiments relates to a lower protective cover and a battery pack having the same.

### 2. Description of the Related Art

In general, electric vehicles are vehicles that obtain power by driving an AC or DC motor using power supplied from a battery. Electric vehicles may be largely classified into battery-exclusive electric vehicles and hybrid electric vehicles.

Battery-exclusive electric vehicles drive a motor using power from a battery and recharge the battery when the power is exhausted. In the case of the battery-exclusive electric vehicle, a plurality of battery packs may be mounted on a lower portion thereof. The electric vehicle has a high risk of battery damage due to an impact to the lower portion of the vehicle caused by various events while driving, such as striking debris or obstacles in the roadway. Therefore, it is desirable to have a system and method capable of preventing the damage of the battery due to the impact to the lower portion of the electric vehicle.

The above-described information disclosed in the technology that serves as the background of the present disclosure is only for improving understanding of the background of the present disclosure and thus may include information that does not constitute the related art.

### SUMMARY

Aspects of some embodiments of the present disclosure provide a lower protective cover capable of effectively protecting a battery cell against a lower impact, and a battery pack having the same.

According to some embodiments, a battery pack includes: a battery module accommodating a number of battery cells; and a lower protective cover including a lower panel detachably coupled to a lower portion of the battery module and a number of buffer parts on one surface of the lower panel.

The lower panel may have a plate shape, and the buffer parts may be provided on a surface of the lower panel facing the battery module.

The buffer parts may extend in a longitudinal direction of the lower panel and may each have a hollow pipe shape.

Each of the buffer parts may include a top surface and a bottom surface, each being parallel to the lower panel, and left and right side surfaces connecting the top surface to the bottom surface.

Each of the left and right side surfaces may have an inward concave shape.

Each of the left and right side surfaces may have an outward convex shape.

Each of the left and right side surfaces may have a number of concave portions and a number of convex portions.

The battery pack may also include a number of cooling passages in a lower portion of the battery module, and the cooling passages may be between adjacent buffer parts.

Each of the cooling passages may be sized such that they are not in contact with the lower panel.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

These and other features and advantages of embodiments of the present disclosure will become more apparent by reference to the following detailed description when considered in conjunction with the following drawings. In the drawings, like reference numerals are utilized throughout the drawings to reference like features and components. The drawings are not necessarily drawn to scale.

FIG. 1 illustrates a perspective view of a lower portion of a battery pack according to embodiments of the present disclosure;

FIG. 2 illustrates an exploded perspective view of the battery pack of FIG. 1;

FIG. 3 illustrates a cross-sectional view taken along line A-A′ of FIG. 2;

FIG. 4 illustrates an enlarged cross-sectional view of a buffer part of a lower protective cover of FIG. 3;

FIGS. 5 and 6 illustrate enlarged cross-sectional views of a buffer part of a lower protective cover according to other embodiments of the present disclosure;

FIG. 7 illustrates a cross-sectional view of the battery pack and a lower impact generation direction in FIG. 1; and

FIGS. 8A and 8B illustrate a view of a state of main portions when a lower impact occurs in the battery pack of FIG. 7.

### DETAILED DESCRIPTION

Embodiments of the present disclosure may, however, be embodied in many different forms and should not be construed as being limited to the embodiments set forth herein; rather, these embodiments are provided so that those skilled in the art thoroughly understand the present disclosure. Rather, these embodiments are provided so that this disclosure will be thorough and complete, and will fully convey the scope of the present disclosure to those skilled in the art.

In addition, in the following drawings, the thickness or size of each layer is exaggerated for convenience and clarity of description, and the same reference numerals in the drawings refer to the same elements. As used herein, the term “and/or” includes any and all combinations of one or more of the associated listed items. In this specification, it will also be understood that if a member A is referred to as being connected to a member B, the member A can be directly connected to the member B or indirectly connected to the member B with a member B therebetween.

The terms used in this specification are for illustrative purposes of the present disclosure only and should not be construed to limit the meaning or the scope of the present disclosure. As used in this specification, a singular form may, unless definitely indicating a particular case in terms of the context, include a plural form. Also, the expressions “comprise/include” and/or “comprising/including” used in this specification neither define the mentioned shapes, numbers, steps, operations, members, elements, and/or groups of these, nor exclude the presence or addition of one or more other different shapes, numbers, steps, operations, members, elements, and/or groups of these, or addition of these. The term “and/or” used herein includes any and all combinations of one or more of the associated listed items.

As used herein, terms such as “first,” “second,” etc. are used to describe various members, components, areas, layers, and/or portions. However, it is obvious that the members, components, areas, layers, and/or portions should not be defined by these terms. The terms do not mean a particular order, up and down, or superiority, and are used only for distinguishing one member, component, area, layer, or portion from another member, component, area, layer, or portion. Thus, a first member, component, area, layer, or portion which will be described may also refer to a second member, component, area, layer, or portion, without departing from the teaching of the present disclosure.

Spatially relative terms, such as “below”, “beneath”, “lower”, “above”, “upper” and the like, may be used herein for ease of description to describe one element or feature's relationship to another element(s) or feature(s) referring to the figures. These spatially relative terms are intended for easy comprehension of the prevent invention according to various process states or usage states of the prevent invention, and thus, the present disclosure is not limited thereto. For example, an element or feature shown in the drawings is turned inside out, the element or feature described as “beneath” or “below” may change into “above” or “upper”. Thus, the term “lower” may encompass the term “upper” or “below”.

Hereinafter, a lower protective cover and a battery pack having the same according to embodiments will be described in detail with reference to the accompanying drawings.

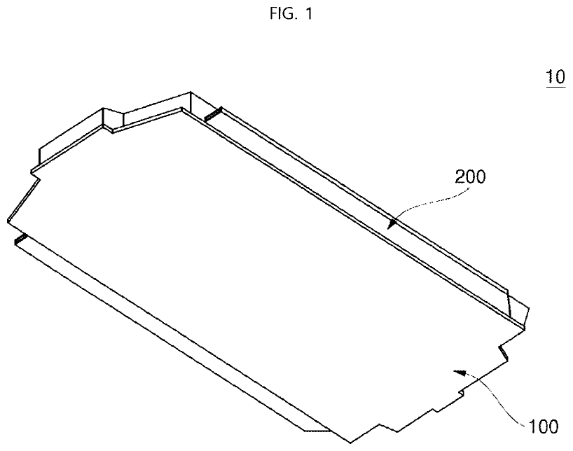

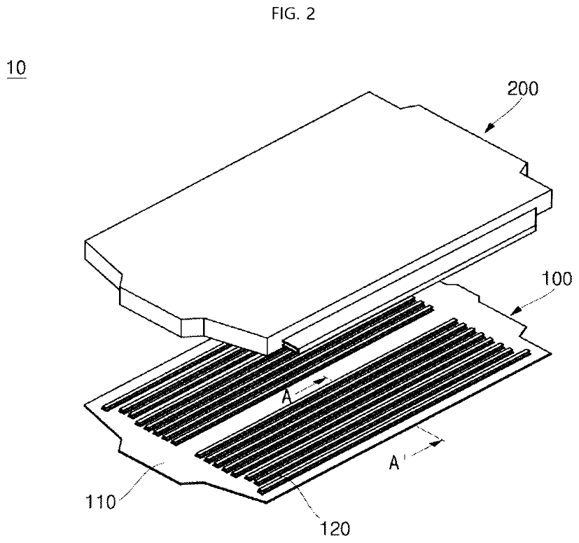

FIG. 1 illustrates a perspective view of a lower portion of a battery pack according to embodiments. FIG. 2 illustrates an exploded perspective view of the battery pack of FIG. 1.

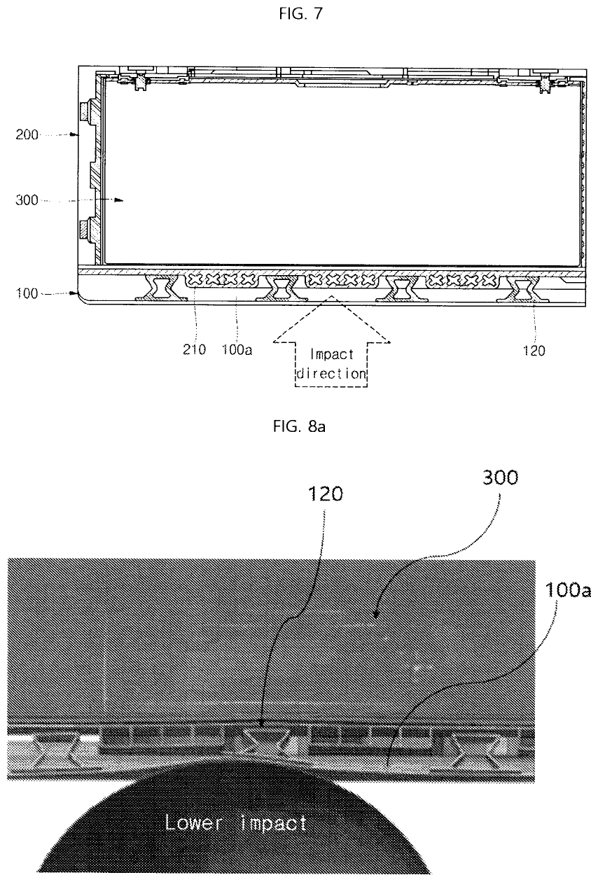

Referring to FIGS. 1 and 2, a battery pack 10 according to embodiments may include a lower protective cover 100 seated on an installation surface of a vehicle, etc., and a battery module 200 that accommodates and covers a plurality of battery cells 300 (see FIG. 7). The lower protective cover 100 may be detachably coupled to a lower portion of the battery module 200. Thus, when the lower protective cover 100 is damaged, only the lower protective cover 100 may be separated to be replaced.

The lower protective cover 100 may include a lower panel 110 having a substantially rectangular plate shape and a plurality of buffer parts 120 provided on the lower panel 110 (e.g., on an upper surface of the lower panel 110).

The shape of the lower panel 110 may correspond to a lower shape of the battery module 200. Since the lower panel 110 supports the battery module 200 from a lower side, the lower panel 110 may have a size capable of completely covering (or substantially completely covering) the lower portion of the battery module 200. Since the lower panel 110 has to be able to prevent the battery module 200 from being damaged, the lower panel 110 may be made of various materials such as steel, aluminum, and a material mixed with various materials (e.g., an alloy). In some embodiments, when the lower panel 110 is made of aluminum, the lower panel 110 may be manufactured through a stamping method. Referring to FIG. 2, the plurality of buffer parts 120 may be coupled to a top surface of the lower panel 110 and extend in a longitudinal direction along the length of the lower panel 110.

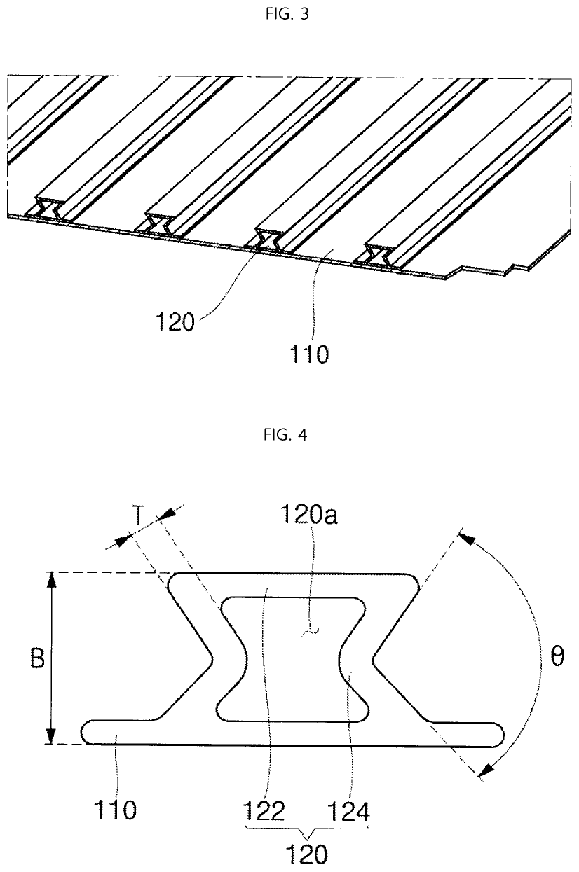

FIG. 3 illustrates a cross-sectional view taken along line A-A′ of FIG. 2. FIG. 4 illustrates an enlarged cross-sectional view of the buffer part of the lower protective cover of FIG. 3.

Referring to FIGS. 2 to 4, the plurality of buffer parts 120 may be disposed in the longitudinal direction on the top surface of the lower panel 110. The buffer part 120 may be manufactured through an extrusion method and may be made of the same material as the lower panel 110. In some embodiments, the buffer parts 120 may be coupled to the lower panel 110 by welding. In the illustrated embodiment, each of the buffer parts 120 has a length less than that of the lower panel 110 and each may have a hollow pipe shape or a hollow prismatic shape. In some embodiments, the buffer parts 120 may have various cross-sectional shapes, but may have a cross-sectional shape capable of absorbing an impact. When the buffer parts 120 are seated on the lower panel 110 (in some embodiments, the buffer part is provided to have a separate bottom surface, but since the bottom surface is welded and connected to the lower panel 110, reference numerals of the bottom surface are omitted for convenience), the buffer parts 120 may include a top surface 122 spaced apart from and facing and parallel to the bottom surface and left and right surfaces 124 connecting the bottom surface to opposite sides or ends of the top surface 122. The buffer part 120 may have a hollow interior 120a having various shapes depending on the shapes of the bottom surface, the top surface 122, and the left and right surfaces 124. Each of the left and right surfaces 124 may be concave inward from an end of the top surface 122 or the bottom surface (e.g., the left and right surfaces 124 may extend concavely inward into the hollow interior 120a). In some embodiments, each of the left and right surfaces 124 may have a shape of which an approximately center in a vertical direction in FIG. 4 is concave. In some embodiments, the hollow interior 120a may have a substantially hourglass-like shape. The shape of the buffer parts 120 having the hollow interiors 120a may have a structure for absorbing an impact applied from the lower side of the lower protective cover 100. That is, the left and right surfaces 124 may absorb the impact while being compressed or deformed in the vertical direction (direction B in FIG. 4) by an impact in a downward direction. In some embodiments, the impact applied to the battery cell 300 may be absorbed by the deformation of the buffer parts 120.

A degree of inward concaveness of each of the left and right surfaces 124 may be indicated by a central angle (theta (θ)) in FIG. 4. In some embodiments, a thickness of each of the left and right surfaces 124 may be indicated by reference symbol T in FIG. 4. In some embodiments, an angle θ of each of the left and right sides 124 of the buffer part 120 may be in the range of about 90 degrees to about 120 degrees. In some embodiments, the thickness of each of the left and right surfaces 124 may be in the range of about 1.5 mm to about 3 mm. An impact absorption amount may be adjusted by adjusting the angle and thickness of the side surface 124. Exemplary impact absorption amounts for each thickness and angle of the side surface 124 are shown in the table below.

| Thickness (mm) | Angle (°) | Impact absorption amount (kN) |
|---|---|---|
| 1.5 | 90 | 10 |
| 2.0 | 100 | 20 |
| 2.5 | 110 | 30 |
| 3.0 | 120 | 40 |

Referring to FIGS. 1 and 2, the battery module 200 may have a substantially rectangular parallelepiped shape, and the plurality of battery cells 300 may be mounted in the battery module 200. Referring to FIG. 7, a plurality of cooling passages 210 may be provided in the bottom surface of the battery module 200 in the longitudinal direction. The cooling passage 210 may be disposed so as not to overlap the buffer part 120 described above (e.g., two or more cooling passages 210 may be between adjacent buffer parts 120). In some embodiments, a protruding width of each of the cooling passages 210 (width in the vertical direction in FIG. 7) may be less than that of the buffer part 120 (width in the vertical direction in FIG. 7). That is, in one or more embodiments the cooling passages 210 may be shorter than the buffer parts 120 in the vertical direction B (shown in FIG. 4). In some embodiments, an empty space may be generated between the cooling passage 210 and the buffer 120 (e.g., gaps may be provided between the cooling passages 210 and the buffer parts 120 and/or between the cooling passages 210 and the lower panel 110). The empty space may serve to buffer an impact generated from the lower side of the lower protective cover 100. In some embodiments, the above-described empty space may be defined as an impact absorbing space 100a. The impact absorbing space 100a may be an entire empty space inside the lower protective cover 100 except for the buffer 120 and the cooling passage 210. The above-described arrangement and shape of the cooling passage 210 and the buffer part 120 and the structure of the impact absorbing space 100a may be configured to prevent the cooling passage 210 and the battery cell 300 from being damaged even though the buffer part 120 is deformed by the impact applied from the lower side of the lower protective cover 100.

The buffer part 120 described above may be implemented in various forms.

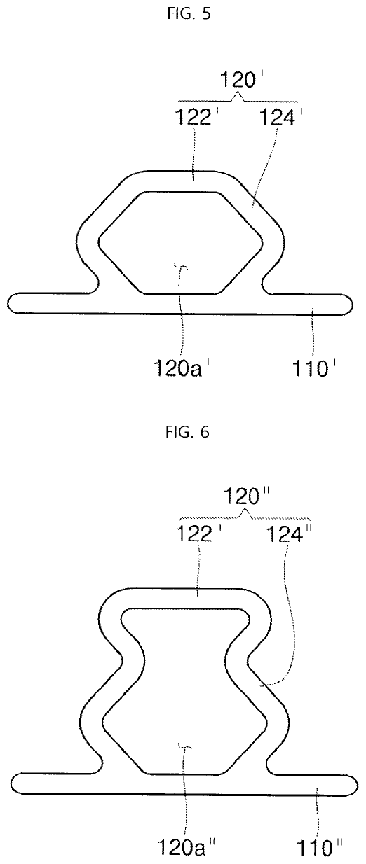

FIGS. 5 and 6 illustrate enlarged cross-sectional views of a buffer part of a lower protective cover according to other embodiments of the present disclosure.

Referring to FIG. 5, a buffer part 120′ may include a bottom surface (not separately marked with reference number) parallel to a lower panel 110′, a top surface 122′ spaced apart from and facing and parallel to the bottom surface, and left and right surfaces 124′ connecting the bottom surface to opposite sides or ends of the top surface 122′. In some embodiments, each of the left and right surfaces 124′ may have a shape of which an approximately central portion in a vertical direction protrudes outward (e.g., the left and right surfaces 124′ may extend convexly outward away from the hollow interior 120a′). In some embodiments, the hollow interior 120a′ defined by the top and bottom surfaces 122′ and the left and right surfaces 124′ may have a substantially hexagonal shape. When an impact occurs from a lower side, the buffer part 120′ may also be deformed in the vertical direction in FIG. 5 to absorb the impact.

In some embodiments, referring to FIG. 6, a buffer part 120″ may include a bottom surface (not separately marked with reference number) parallel to a lower panel 110″, a top surface 122″ spaced apart from and facing and parallel to the bottom surface, and left and right surfaces 124″ connecting the bottom surface to opposite sides or ends of the top surface 122″. In some embodiments, each of the left and right surfaces 124″ may have a shape having both an inward concave portion and an outward protruding (convex) portion. Such a shape may be referred to as a concave-convex or wrinkled shape, a zigzag shape, or the like. In some embodiments, each of the concave portion and the convex portion may be repeated (provided in plurality). In some embodiments, a hollow interior 120a″ defined by the top and bottom surfaces 122″ and the left and right surfaces 124″ may be provided in an irregular (atypical) shape.

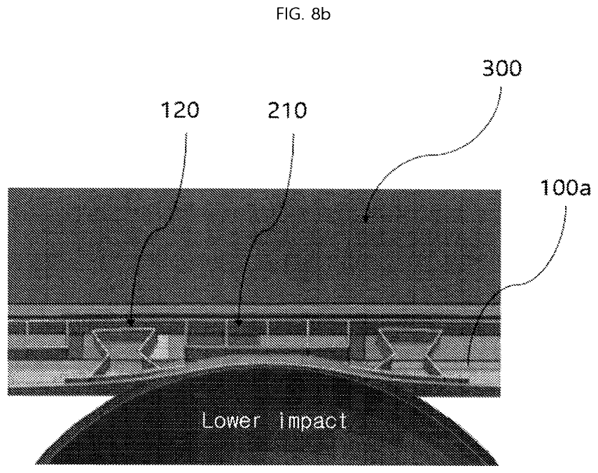

In the battery pack according to some embodiments having the above-described configuration, an event in which an impact occurs from a lower side will be described (for convenience, reference numbers in FIGS. 7 to 8B are indicated based on the embodiment of FIG. 5).

FIG. 7 illustrates a cross-sectional view of the battery pack and a lower impact generation direction in FIG. 1. FIGS. 8A and 8B illustrate a view of a state of battery pack when the lower impact occurs in the battery pack of FIG. 7.

Since the battery pack 10 is mainly mounted on the lower portion of the electric vehicle, the impact may often transmitted from the lower portion of the battery pack 10 according to conditions of a road surface (e.g., debris or obstacles on the road) referring to FIG. 7. In some embodiments, an impact transmission portion may be a position of the buffer part 120 referring to FIG. 8A or may be a cooling passage 210 between the buffer parts 120 referring to FIG. 8B.

Referring to FIG. 8A, when the impact is transmitted to the position of the buffer part 120, the buffer part 120 may be deformed to absorb the impact, thereby minimizing the transmission of the impact to the cooling passage 210 or the battery cell 300 or preventing the impact from being transmitted to the cooling passage 210 or the battery cell 300.

Referring to FIG. 8B, when the impact is transmitted to the position of the cooling passage 210 between the buffer parts 120, the impact absorbing space 100a may serve as the buffer part 120. In some embodiments, since there are buffer parts 120 at both sides of the impact absorbing space 100a to absorb some impacts, the transmission of impacts to the cooling passage 210 or the battery cell 300 can be minimized or prevented.

According to some embodiments, the structure of the lower protective cover of the battery pack may be improved to absorb the impact from the lower side of the vehicle.

In addition, the cross-sectional shape of the buffer part of the lower protective cover may be changed to adjust and design the impact absorption value.

The above-mentioned embodiment is merely an embodiment, and thus, the present disclosure is not limited to the foregoing embodiment, and also it will be understood by those of ordinary skill in the art that various changes in form and details may be made therein without departing from the spirit and scope of the present disclosure as defined by the following claims.

What is claimed is:

1. A battery pack comprising:
a battery module accommodating a plurality of battery cells; and
a lower protective cover comprising a lower panel detachably coupled to a lower portion of the battery module and a plurality of buffer parts on one surface of the lower panel.

2. The battery pack as claimed in claim 1, wherein the lower panel has a plate shape, and the plurality of buffer parts are on a surface of the lower panel facing the battery module.

3. The battery pack as claimed in claim 2, wherein each buffer part of the plurality of buffer parts extends in a longitudinal direction of the lower panel and has a hollow pipe shape.

4. The battery pack as claimed in claim 3, wherein each buffer part of the plurality of buffer parts comprises a top surface and a bottom surface each being parallel to the lower panel, and left and right side surfaces connecting the top surface to the bottom surface.

5. The battery pack as claimed in claim 4, wherein each of the left and right side surfaces has an inward concave shape.

6. The battery pack as claimed in claim 4, wherein each of the left and right side surfaces has an outward convex shape.

7. The battery pack as claimed in claim 4, wherein each of the left and right side surfaces has a plurality of concave portions and a plurality of convex portions.

8. The battery pack as claimed in claim 5, further comprising a plurality of cooling passages in a lower portion of the battery module, and wherein the cooling passages are between adjacent buffer parts of the plurality of buffer parts.

9. The battery pack as claimed in claim 6, further comprising a plurality of cooling passages in a lower portion of the battery module, and wherein the cooling passages are between adjacent buffer parts of the plurality of buffer parts.

10. The battery pack as claimed in claim 7, further comprising a plurality of cooling passages in a lower portion of the battery module, and wherein the cooling passages are between adjacent buffer parts of the plurality of buffer parts.

11. The battery pack as claimed in claim 8, wherein each cooling passage of the plurality of cooling passages has a size that is not in contact with the lower panel.

12. The battery pack as claimed in claim 9, wherein each cooling passage of the plurality of cooling passages has a size that is not in contact with the lower panel.

13. The battery pack as claimed in claim 10, wherein each cooling passage of the plurality of cooling passages has a size that is not in contact with the lower panel.

14. The battery pack as claimed in claim 1, further comprising a plurality of cooling passages in a lower portion of the battery module, and wherein the cooling passages are between adjacent buffer parts of the plurality of buffer parts.

15. The battery pack as claimed in claim 14, wherein each cooling passage of the plurality of cooling passages has a size that is not in contact with the lower panel.
